(19) United States
(12) Patent Application Publication
(10) Pub. No.: US 2012/0160350 A1
(43) Pub. Date: Jun. 28, 2012

(54) MINIATURE HYDROELECTRIC POWER PLANT

(76) Inventor: Ivano Crugnale, Toul Cedex (FR)

(21) Appl. No.: 13/393,639

(22) PCT Filed: Aug. 30, 2010
(86) PCT No.: PCT/FR10/51799

§ 371 Date: Mar. 1, 2012

(30) Foreign Application Priority Data
Sep. 1, 2009 (FR) 09 55942
Sep. 1, 2009 (FR) 09N 55942

(51) Int. Cl. F17D 3/00; F03B 13/08

(52) U.S. Cl. 137/560; 290/52

(57) ABSTRACT

A miniature hydroelectric power plant has a storage tank and a penstock for the flow of the water toward a recovery tank. A turbine is connected to a power generator and arranged in the penstock. The water with which the storage tank is supplied is fed from the recovery tank using a wheel provided with containers. The wheel is rigidly connected to a driving device engaging with a driving means. The miniature power plant is characterized in that the driving means is actuated by a self-contained and ecological source.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT Not applicable.

### REFERENCE TO AN APPENDIX SUBMITTED ON COMPACT DISC

Not applicable.

### BACKGROUND OF THE INVENTION

1. Field of the Invention

The invention concerns the field of energy production, more particularly production of electricity.

2. Description of Related Art Including Information Disclosed Under 37 CFR 1.97 and 37 CFR 1.98.

It has been known for many years to employ renewable and non-polluting energy sources that do not generate CO₂, for example solar energy, wind energy, wave, marine current and tidal energy.

Environmentally friendly energies have a drawback shared with power stations using oil or coal to generate electricity, which is the difficulty or even impossibility of storage for use as close as possible to demand.

Moreover, it should be noted that renewable and non-polluting energies such as photovoltaic energy and wind energy are growing rapidly in domestic installations and that it is already possible to produce small power stations able to supply a neighborhood or small industrial establishments with electricity.

This growth of small power stations is however slowed by the problem of energy storage and energy availability as a function of present consumption.

In an attempt to solve this problem, installations that generate energy are connected to the electrical grid and energy produced but not used locally is sold on, and moreover if domestic production is insufficient the user uses electricity from the grid and is billed accordingly.

This solution appears relatively unsatisfactory for many users who require complete energy independence and because of the amount paid by the local electricity distributor, which is not negotiable with private persons.

The problem of growing renewable energies at the domestic level and at the level of local collectivities is thus necessarily linked to that of storing the energy produced.

An objective of the invention is therefore to solve this main problem by proposing a miniature hydroelectric power station associated with any renewable energy production system in such a manner as to store energy and to make it available as a function of the requirements of users.

### BRIEF SUMMARY OF THE INVENTION

The present invention provides a miniature hydroelectric power station comprising a storage reservoir and a forced pipe for the flow of water to a recovery tank, a turbine connected to an electricity generator being placed in the pipe, the water feeding the storage reservoir being supplied from the recovery tank by supply means activated by drive means actuated by an autonomous and ecological energy source. According to the invention, the supply means comprise a wheel provided with containers, which wheel is rigidly fastened to a drive system interengaged with drive means, and the drive system is a toothed wheel of large diameter coaxial with the wheel provided with containers.

The miniature power station of the invention has the advantage of enabling storage of energy and its use on demand, although the device may equally be used for irrigation coupled with energy production.

Another advantage of the device is that it employs proven, and therefore highly reliable, technologies, the investment costs of which may be amortized relatively quickly.

Other features and advantages of the invention emerge from the following description with reference to the appended drawings, which are provided by way of nonlimiting example only.

### BRIEF DESCRIPTION OF THE DRAWINGS

FIG. 1 is a block diagram of the miniature power station.

FIG. 2 is a detailed view of the water raising device.

### DETAILED DESCRIPTION OF THE INVENTION

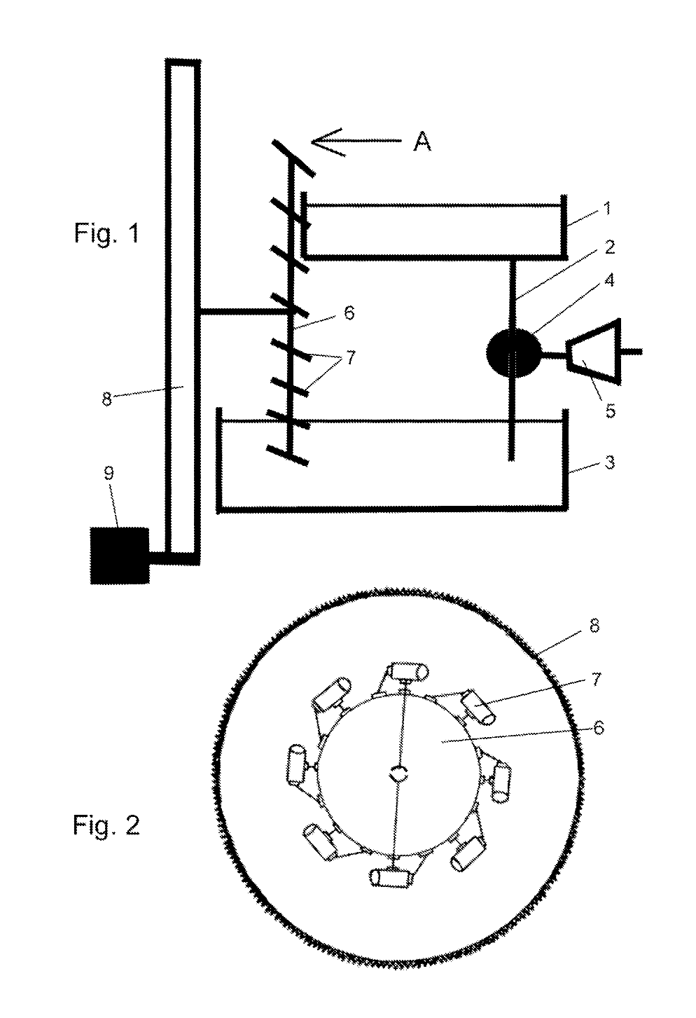

As shown in FIG. 1, the miniature hydroelectric power station includes a storage reservoir 1 and a forced pipe 2 for flow of water to a recovery tank 3, and a turbine 4 connected to an electricity generator 5 being placed in the pipe.

The water supplied to the storage reservoir 1 is taken from the recovery tank 3 by means of supply means activated by drive means 9 actuated by an autonomous and ecological energy source.

According to the invention, the supply means are of the water raising device type including a wheel 6 provided with containers 7 and rigidly fastened to a driving device 8 mechanically connected to the driving means 9 to drive rotation of the system. The driving device 8 is a toothed wheel of large diameter coaxial with the wheel 6 provided with containers 7.

An autonomous energy source must be understood as an energy producing system enabling the wheel 6 to be driven in rotation via the driving device 8. For example, a wind turbine may be coupled via a transmission to transform the energy of the wind directly into a rotation movement that may be used to raise water. An alternative is for a set of photovoltaic cells to supply a standard electric motor, for example.

An ecological energy source must be understood as an energy source not generating CO₂, notably what is known as renewable energy, for example solar energy or wind energy.

Thus in a first embodiment of the invention the energy source corresponds to photovoltaic panels. In a second variant of the invention the energy source is formed by a wind turbine system. In a third variant the energy source corresponds to photovoltaic panels coupled to a wind turbine system. The latter variant enables the power station to operate day and night.

The effect of the drive means 9 is to cause the drive means 8 rigidly fastened to the wheel 6 that carries the containers 7 to turn.

FIG. 2 shows in the observation direction A represented in FIG. 1 the combination of the drive system 8 and the wheel 6 carrying the containers 7.

The drive device 8 takes the form of a toothed wheel of large diameter meshing with the drive means 9, the wheel 6 supporting a plurality of containers adapted to collect water in the recovery tank 3 to transfer it into the storage reservoir 1. This wheel is therefore partially immersed in said recovery tank.

Thus according to the invention the drive device is a toothed wheel of large diameter coaxial with the wheel provided with containers. The greater the diameter of the toothed wheel, the greater the volume of water transported and the lower the energy expenditure of the installation. This is the opposite of what is obtained with a pump, where the more its capacity is increased, the greater is the energy expenditure of the installation.

The storage reservoir 1 is advantageously provided with a solenoid valve for interrupting the flow of water, enabling the miniature power station to be used only when required.

The storage reservoir 1 advantageously further includes a valve for directing water to an irrigation system.

This variant of the device may be used to move water from a low point to a high point using an autonomous and ecological energy source.

According to the invention, the irrigation system may be fed at the same time as producing electricity if both valves are open.

In a different configuration the irrigation system is fed alternately with the production of electricity, as a function of the requirements for electricity and for water for irrigation.

Obviously the valves that orient the water toward irrigation or toward the forced pipe 2 may be controlled by a controller of the operation of the installation and/or function manually.

The operation of the miniature hydraulic power station is advantageously linked to the management of the operation of the drive means and thus to the autonomous and ecological energy source. The optimum is for the autonomous and ecological energy source to produce electricity and to activate the miniature power station during periods of underconsumption in such a manner as to store energy.

In an advantageous embodiment of the invention the miniature hydroelectric power station has the following features:

The drive means 9 comprises a wind turbine, the drive device 8 is a toothed wheel with a diameter of 28 meters, the wheel 6 has a diameter of 10 meters and carries 16 containers, each cylindrical container is capable of carrying 3.6 m³, the storage reservoir has a capacity of about 200 m³, 6 m³ of water flowing per second in the forced pipe enables generation of 240 kWh of electricity.

Numerous variants of the miniature hydroelectric power station are possible; without departing from the scope of the invention, the drive means may notably be defined within a range of techniques according to particular aspects of the installation site, hours of sunshine or high winds and according to various local criteria enabling optimization of the system.

Without departing from the scope of the invention, the dimensions of each part of the installation for storing water, and therefore energy, may vary over a wide range.

Of course, the invention is not limited to the embodiments described and shown by way of example, and also comprises all technical equivalents and combinations thereof.

1. Miniature hydroelectric power station comprising a storage reservoir and a forced pipe for the flow of water to a recovery tank, a turbine connected to an electricity generator being placed in the pipe, the water feeding the storage reservoir being supplied from the recovery tank by supply means activated by drive means actuated by an autonomous and ecological energy source, characterized in that the supply means comprise a wheel provided with containers, which wheel is rigidly fastened to a drive system interengaged with drive means, the drive system being a toothed wheel of large diameter coaxial with the wheel provided with containers.

2. Miniature hydroelectric power station according to claim 1 wherein the energy source comprises at least photovoltaic panels.

3. Miniature hydroelectric power station according to claim 1 wherein the energy source comprises at least a wind turbine system.

4. Miniature hydroelectric power station according to claim 1 wherein the storage reservoir is provided with a solenoid valve for interrupting the flow of water.

5. Miniature hydroelectric power station according to claim 1 wherein the storage reservoir further includes a valve for directing water to an irrigation system.

6. Miniature hydroelectric power station according to claim 6 wherein the irrigation system is fed simultaneously with the production of electricity.

7. Miniature hydroelectric power station according to claim 6 wherein the irrigation system is fed alternately with the production of electricity, as a function of the requirements for electricity or for water for irrigation.
